(19) United States
(12) Patent Application Publication
(10) Pub. No.: US 2003/0173435 A1
(43) Pub. Date: Sep. 18, 2003

(54) Grating device

(76) Inventor: Reinaldo Hernandez, Kissimmee, FL (US)

Correspondence Address: Elsie C. Turner, Suite 204, 201 Park Place, Altamonte Springs, FL, 32701, US

(21) Appl. No.: 10/347,424

(22) Filed: Jan. 21, 2003

Related U.S. Application Data
(60) Provisional application No. 60/364,250, filed on Mar. 13, 2002.

(51) Int. Cl. B02C 19/20

(52) U.S. Cl. 241/92

(57) ABSTRACT

An improved grating accessory disc for use with an electric food processor has a center opening configured to fit the rotor of the electric food-processor, which will vary, along with the diameter of the disc, according to the particular brand of food processor. The grating elements of the disc are like those of a conventional manual grater: a multiplicity of saw-toothed protrusions resulting from the piercing of holes through a thin disc, preferably sheet metal, with a pointed spike, so that all of the protrusions are on the same surface of the disc.

Applicant of this formal utility application claims the benefit of a previously filed provisional application, Serial No. 60/364,250, filed Mar. 13, 2002.

### FIELD OF THE INVENTION

The present invention relates to food grinding apparatus. More particularly, this invention is for a removable grating disc for use in a conventional electric food processor, the disc being particularly suited for grating the vegetables used in recipes for Puerto Rican pasteles. These are steamed, leaf-wrapped packets of masa (dough) and relleno (filling), traditionally served at Christmas-time or on other holidays.

Recipes for the masa for pasteles call for potatoes or yams and green plantains or yucca which are grated while raw. It is critical to the ideal texture and consistency of the masa that the grated vegetables yield a soft dough of wet sticky consistency. Traditionally the vegetables have been laboriously grated manually using a conventional grating surface with a multiplicity of saw-toothed protrusions formed by piercings of the grating surface. Not only is this hand method time-consuming, but it is also physically grueling. Attempts to lighten the task with an electric food processor to grate the vegetables, using an accessory commonly supplied with the many brands of food processors designed for home use and widely available to consumers through various outlets, usually produce undesirable results. Various manufacturers of small appliances market such machines, which typically consist of a stand containing an electric motor with a drive shaft in the base, on which the bowl of the processor rests. The bowl has a center tubular column through which removable rotors are inserted to connect to the drive shaft, which rotors cause the selected food-processing tool to rotate and thereby mix, grind, slice, chop, shred, or blend food fed to the tool through a chute extending upward from the bowl cover. A “pusher” fitting within the food chute is typically provided to bias the food to be processed against the processing disc. The bowl and cover remain stationary during operation. One of the tools typically provided is a removable, reversible disc which either shreds or slices, depending on which surface is facing upward, food fed to it through the chute. The disc rotates on an extended rotor shaft, linked to the motor, a slight distance below the bowl cover, and the processed food falls into the bowl. Another removable tool is an S-blade for mixing, blending and grinding that rotates inside the bowl. The reversible disc tool has a slicing blade protruding from one face thereof, and U-shaped shredding edges protruding from the converse face thereof. The vegetable shreds produced by the U-shaped shredding edges are strands that are too large to produce an acceptable masa, and particles produced by the S-blade or by an electric blender are too fine, producing too soupy a dough. Accordingly there is a need to provide a grating accessory for home-use electric food processors which will produce the right consistency, size and texture of grated raw vegetables and fruits, for making various dishes including an acceptable masa for pasteles,

### SUMMARY OF THE INVENTION

An improved grating accessory disc is provided for use with a home-use electric food processor. The disc has a center opening configured to fit the rotor of a conventional electric food-processor designed for the home user, which will vary, along with the diameter of the disc, according to the particular brand of food processor. The grating elements of the disc are very similar to those of a conventional manual grater: a multiplicity of saw-toothed protrusions resulting from the piercing of holes through a thin disc, preferably metal, with a pointed spike, so that all of the protrusions are on the same surface of the disc.

### BRIEF DESCRIPTION OF THE DRAWINGS

FIG. 1 is a perspective view of my invention;

FIG. 2 is top plan view thereof;

FIG. 3 is a side elevational view thereof.

FIG. 4 is a perspective exploded view of a conventional food processor using the invention in place of its provided shredder/slicer disc.

### DETAILED DESCRIPTION OF THE PREFERRED EMBODIMENT

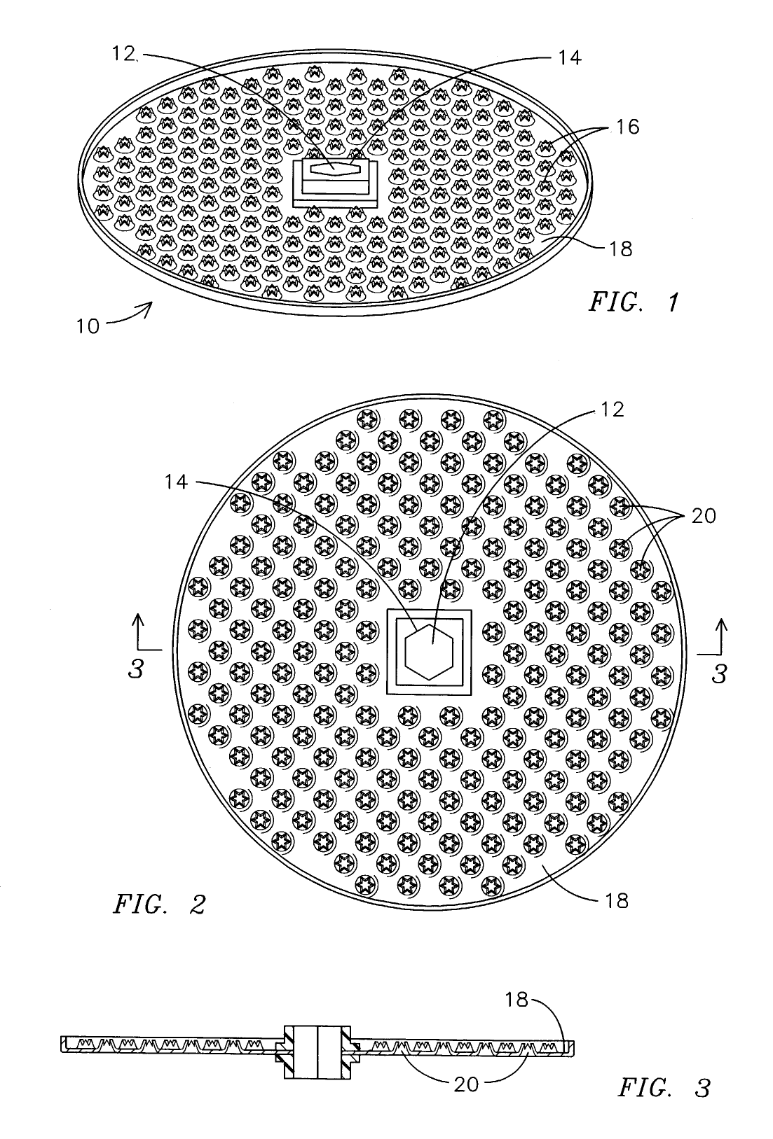

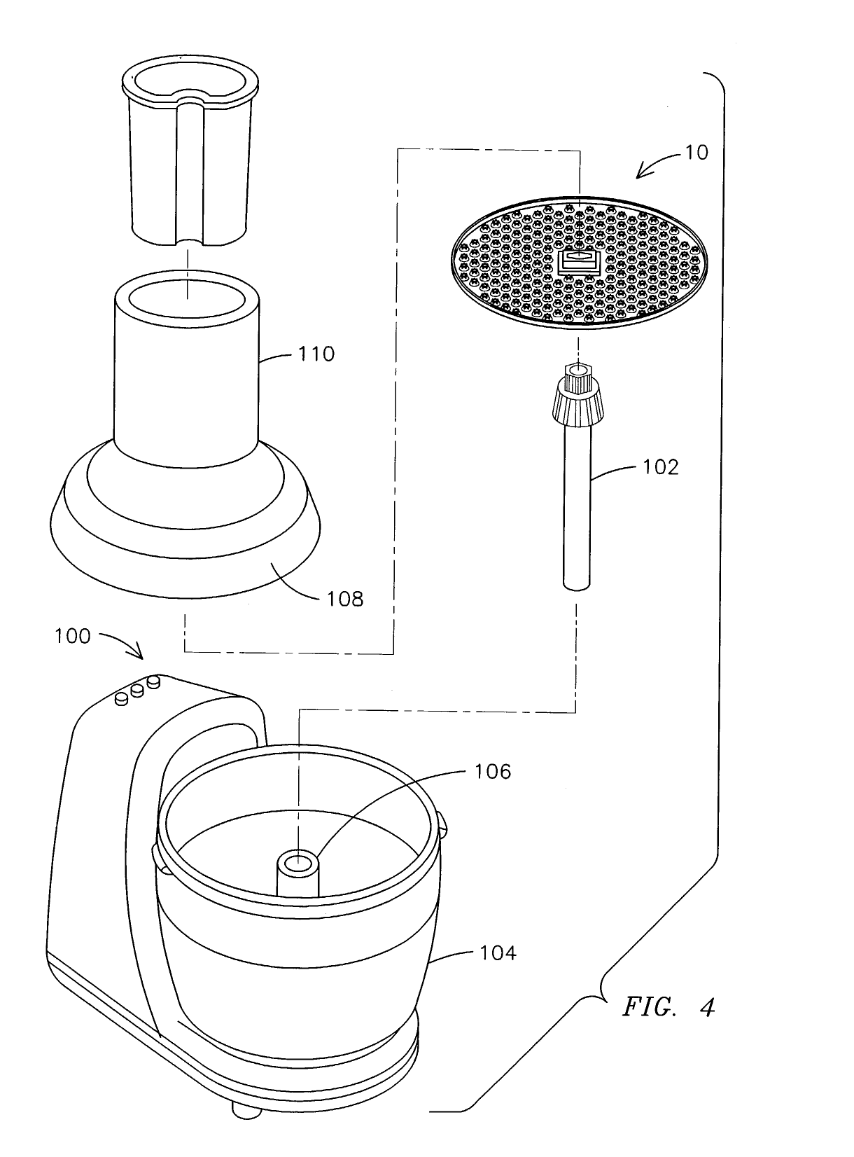

With reference to FIGS. 1-4, there is shown a food-grinding accessory disc 10, preferably of sheet metal, according to the invention, adapted to be used in connection with an electric-powered food processing machine of a type generally designed for the home user and widely available to the public, shown in FIG. 4. The machine 100 has as an accessory a removable rotating shaft 102 intended to drive a shredder/slicer disc, not shown, provided with the machine. Shaft 102 is inserted through a tubular column 106 to connect to the machine's drive mechanism, not shown. Disc 10 has a center opening 12, the edges 14 of which are faceted to mate precisely with the upper, corresponding faceted end of the removable disc-driving shaft 102, so that rotation of the shaft causes rotation of disc 10. A multiplicity of sharp saw-toothed grating elements 16 integral with disc 10 protrude from the upper surface 18 of disc 10. These may be produced most economically by punching or stamping the underside of an unperforated sheet-metal disc with spikes of a selected diameter, thereby cutting apertures 20 and bending upward the material impacted and displaced by the spikes into sharp teeth shaped more or less like pieces of a pie disposed around the perimeters of the resulting apertures 20. Food to be grated is fed to the grating disc 10 through chute 110. Grated food produced by the invention falls through apertures 20 and is collected in the bowl 104 of the food processing machine. The diameter and the spacing of the apertures 20 are critical in that the vegetable gratings must be the right size to create the desired fixture and consistency of masa, and the height of the grating elements 16 must not exceed the clearance space between disc 10 and the underside of the bowl cover 108. The diameter of apertures 20 should range between 3/16 and 5/16 of an inch, and optimally should be ¼ of an inch, producing grating elements 16 that are ⅛ of an inch high. Apertures 20 should be spaced on centers ranging between ¼ and 7/16 of an inch, optimally 5/16 apart. Optimally they should be distributed evenly over substantially all of the disc, as shown in FIGS. 1 and 2, so that the grating process occurs continuously during each rotation of the disc, thereby speeding the grating process. (In contrast, actual grating occurs only during a fraction of a rotation in the case of the a conventional shredder/slicer disk typically supplied with most food processors on the market.) Preferably disc 10 is made of stainless steel.

Changes and modifications in the specifically described embodiments can be made without departing from the scope of the invention, which is intended to be limited only by the scope of the appended claims.

I claim:

1. A removable grating disc for use with a conventional electric food processor, said food processor comprising a base supporting a removable, covered collecting bowl and housing an electric motor connected to a rotating driver in said base, said driver configured to mate with a removable rotor shaft for driving cutting and shredding implements, said collecting bowl having a central tubular column through which said rotor shaft extends from said base to a point near the top of said bowl, the upper end of said rotor shaft configured to mate with, support and rotate said implements under the bowl cover, said bowl having a feeder chute for food to be processed extending upward from its cover, said grating disc comprising:
a disc having an upper surface and a lower surface and having a centered aperture shaped to removably mate with the rotor shaft of said electric food processor, whereby the disc rotates when electric power is supplied to the motor of the food processor;
a plurality of sharp pointed teeth projecting from the upper surface of the disc;
a plurality of apertures through the disc adjacent said teeth, whereby food particles grated by said teeth as the disc rotates may drop through said apertures in the disc into the bowl of the food processor

2. The grating disc according to claim 1 wherein said teeth are integral therewith.

3. The grating disc according to claim 2 wherein said teeth are formed by piercing apertures of a selected diameter with a spike from the lower surface through the upper surface of the disk.

4. The grating disc according to claim 3 wherein said apertures are spaced on approximately 5/16 inch centers throughout substantially all of the disc.

5. The grating disc according to claim 4 wherein said apertures are between 3/16 inch and 5/16 inch in diameter.

6. The grating disc according to claim 4 wherein said apertures are ¼ inch in diameter.

7. The grating disc according to claim 3 wherein said disc is made of sheet metal.
